(19) United States
(12) Patent Application Publication
(10) Pub. No.: US 2018/0328876 A1
(43) Pub. Date: Nov. 15, 2018

(54) DRIVEN SHIELD FLUID SENSOR

(71) Applicant: TOUCHSENSOR TECHNOLOGIES, LLC, Wheaton, IL (US)

(72) Inventor: David A. Gradl, Naperville, IL (US)

(21) Appl. No.: 15/968,390

(22) Filed: May 1, 2018

Related U.S. Application Data
(60) Provisional application No. 62/503,380, filed on May 9, 2017.

(51) Int. Cl. G01N 27/22

(52) U.S. Cl. CPC G01N 27/228; G01N 27/226; G01N 27/223

(57) ABSTRACT

An apparatus for liquid sensing includes a drive electrode and a sense electrode disposed on a substrate in a side-by-side relationship. A dielectric layer overlies the sense electrode. A shield electrode disposed on the dielectric layer overlies the sense electrode. The shield electrode is driven to the same potential as the sense electrode. A controller coupled to the drive electrode and the sense electrode provides an excitation signal to the drive electrode and detects capacitance between the drive electrode and the sense electrode.

### CROSS-REFERENCE TO RELATED APPLICATION

This application claims benefit under 35 U.S.C. § 119 of U.S. Provisional Patent Application No. 62/503,380, filed on May 9, 2017, and incorporates by reference the disclosure thereof in its entirety.

### BACKGROUND AND SUMMARY OF THE INVENTION

The present disclosure is directed to an apparatus for detecting fluid in a vessel using mutual capacitance sensing technology. The apparatus includes a drive electrode, a sense electrode, and a shield electrode overlying the non-fluid side of the sense electrode.

### BRIEF DESCRIPTION OF THE DRAWINGS

FIG. 1 is a side cross-sectional view of a fluid-detecting sensor electrode structure including a drive electrode, a sense electrode, and a shield electrode according to the present disclosure;

FIG. 2 is a top plan view of the electrode structure of claim 1 attached to a vessel containing a fluid;

FIG. 2A is a top plan view of the electrode structure of claim 1 and additional shield electrodes attached to a vessel containing a fluid;

FIG. 3 is a front elevation view of the electrode structure of FIG. 1 attached to a vessel containing a fluid;

FIG. 3A is a front elevation view of an alternative electrode structure attached to a vessel containing a fluid;

FIG. 4 is a schematic diagram of a fluid-detecting sensor according to the present disclosure; and

FIG. 4A is a diagram of an illustrative amplifier and connections to the circuit shown in FIG. 4.

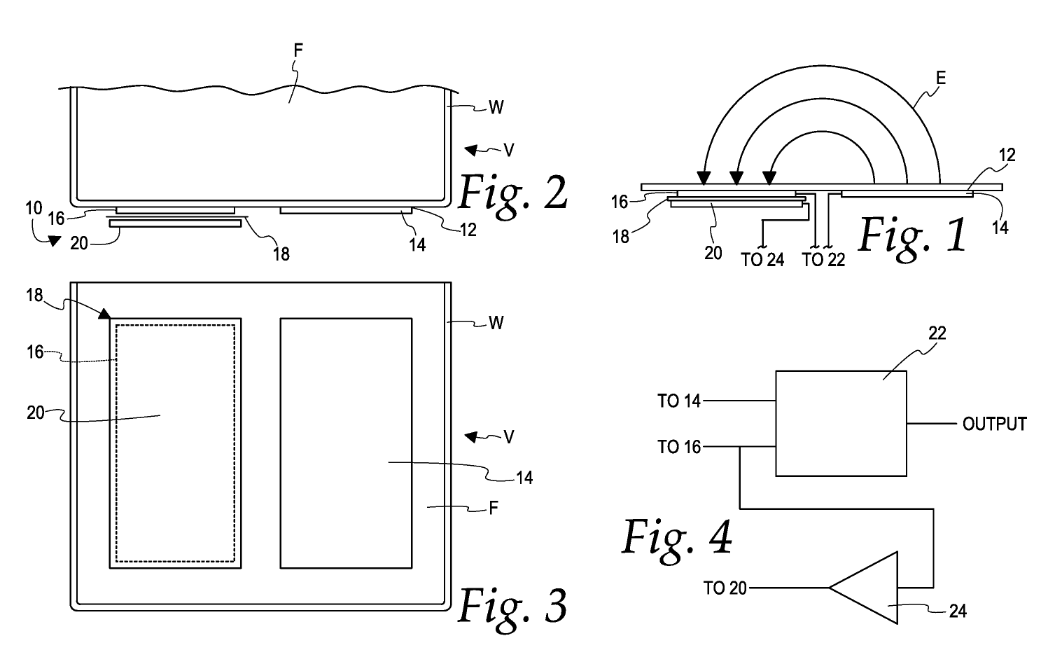

### DETAILED DESCRIPTION OF THE DRAWINGS

The drawings show a fluid-detecting sensor apparatus 10 configured to detect a fluid F, according to the present disclosure. The apparatus 10 is configured for attachment to a vessel, for example, to a side wall of a vessel selectively containing the fluid F, as will be discussed further below.

The sensor apparatus 10 includes a dielectric circuit carrier substrate 12. The substrate 12 may be a printed wiring board or a flexible circuit carrier, for example, a flexible polyester circuit carrier, or another suitable form of circuit carrier.

A first (or drive) electrode 14 is disposed on the substrate 12. The first electrode 14 may be in the form of a thin conductive electrode pad of closed or open geometry. That is, the electrode pad may be solid or in the form of a grid or other open structure. The first electrode 14 may be a low impedance electrode, as would be understood to one skilled in the art. Such a low impedance electrode may have an AC impedance and a DC resistance path to ground sufficiently low to enable the low impedance electrode to resist field-induced effects that might otherwise spuriously change the electrode potential. As such, the low impedance electrode voltage is substantially controlled by the low impedance electrode's voltage ground or driver output terminal, rather than by changes in a surrounding electric field.

A second (or sense) electrode 16 is disposed on the substrate 12 in side-by-side relationship with the first electrode 14. The second electrode 16 may be in the form of a thin conductive electrode pad of closed or open geometry. The second electrode 16 may be of a form the same as, similar to, or different from the first electrode 14. The second electrode 16 may be a high impedance electrode, as would be understood to one skilled in the art. Such a high impedance electrode may have a DC resistance path to ground sufficiently high to enable the high impedance electrode's voltage to change in response to changes in the electric field generated by the low impedance drive electrode for a period of time at least long enough as the time required for a capacitance measurement cycle to occur. Such changes in the electric field may result from corresponding changes in the low impedance drive electrode's voltage.

A dielectric (or insulating) layer 18 is disposed on and overlies the second electrode 16. In an embodiment, the dielectric layer 18 overlies the second electrode 16 in its entirety. The dielectric layer 18 could extend beyond the periphery of the second electrode 16 in any or all directions. In another embodiment, the dielectric layer 18 could overlie less than the entirety of the second electrode 16.

A third (or shield) electrode 20 is disposed on the dielectric layer 18. In an embodiment, the shield electrode 20 overlies the second electrode 16 in its entirety. The shield electrode 20 could extend beyond the periphery of the second electrode 16 in any or all directions. In another embodiment, the shield electrode 20 could overlie less than the entirety of the second electrode. In any event, the dielectric layer 18 electrically insulates the entirety of the shield electrode 20 from the entirety of the second electrode 16.

Any or all of the first electrode 14, the second electrode 16, and the shield electrode 20 could be opaque, optically transparent or translucent. Any or all of the first electrode 14, the second electrode 16, and the shield electrode 20 could be flexible. Although the first electrode 14, the second electrode 16, and the shield electrode 20 are shown in the drawings as rectangular, any or all of them could be of any suitable shape. Also, the respective sizes of and the spacing between the first electrode 14 and the second electrode 16 could be varied as may be desired and suitable. For example, FIG. 3 shows the first electrode 14 and the second electrode 16 having first rectangular shapes and a first spacing therebetween, whereas FIG. 3A shows the first electrode 14 and the second electrode 16 having second rectangular shapes and a second spacing therebetween. More specifically, the first electrode 14 and the second electrode 16 as shown in FIG. 3 have a higher length-to-width ratio than the first electrode 14 and the second electrode 16 as shown in FIG. 3A. Also, the first electrode 14 and the second electrode 16 as shown in FIG. 3 are farther apart from each other than are the first electrode 14 and the second electrode 16 as shown in FIG. 3A. In other embodiments, the first electrode 14 and the second electrode 16 could have shapes and spacing therebetween different from those shown in the drawings. Further, whereas FIGS. 3 and 3A show the first electrode 14 and the second electrode 16 of the respective embodiments being of the same or similar size and shape, the first electrode of a given embodiment could be of different size and/or shape than the second electrode of the given embodiment.

A controller 22 is electrically coupled to the first electrode 14 and the second electrode 16. The controller 22 may be embodied as any suitable form of controller capable of providing an excitation signal to the first electrode 14, receiving signals from the first electrode and the second electrode 16, and processing the received signals to detect changes in capacitance between the first electrode and the second electrode.

An amplifier 24 is electrically coupled between the second electrode 16 and the shield electrode 20. More specifically, an input terminal of the amplifier 24 is electrically coupled to the second electrode 16, and an output terminal of the amplifier is electrically coupled to the shield electrode 20. The amplifier 24 is configured to drive the shield electrode 20 at the same electrical potential as the second electrode 16. The amplifier 24 may be, for example, an operational amplifier or a transmission line driver. FIG. 4A shows the amplifier embodied as an operational amplifier in a non-inverting unity gain configuration.

The controller 22 and the amplifier 24 could be, but need not be, embodied as a single integrated circuit.

The sensor apparatus 10 may include additional components, for example, a power supply (not shown) connected to and providing power to the controller 22 and the amplifier 24, and an output driver (not shown) for controlling another component (not shown), for example, a level indicator or alarm.

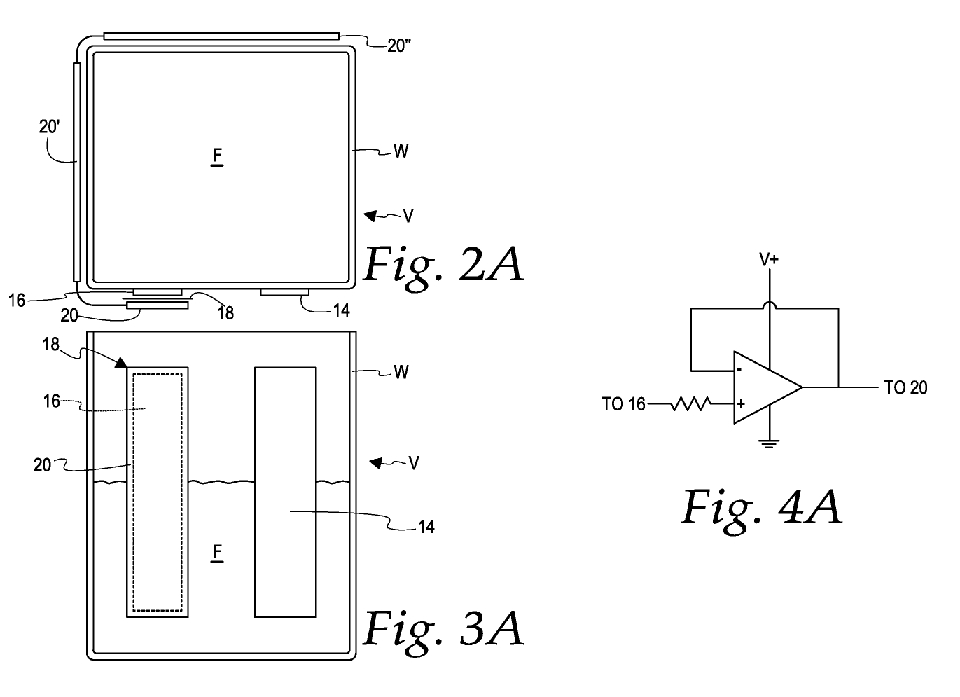

As suggested above, and as shown in FIGS. 2, 2A, 3, and 3A, the apparatus 10 may be applied to a vessel V, for example, to an inner or outer surface of a wall W of a vessel V. In an embodiment, the apparatus 10 may be embedded within the wall W of the vessel V. Any portion of the wall W disposed between the apparatus 10 and the fluid F to be sensed must be electrically non-conductive. Other portions of the wall W could be conductive, if desired. The substrate 12 may be attached to the wall W of the vessel V by an intervening, non-conductive adhesive layer (not shown) or by any other suitable means. Although the vessel V is shown in the drawings as having a square cross-section, it could have any desired and suitable shape. For example, the vessel V could be cylindrical, having an annular wall W.

In an embodiment, one or more additional shield electrodes could be provided to further isolate the second electrode 16 and the interior of the vessel V (and its contents) from external electrical effects. For example, as shown in FIG. 2A, a second shield electrode 20′ could be disposed on a second portion of the vessel wall W, and a third shield electrode 20″ could be disposed on a third portion of the vessel wall. The additional shield electrodes may be electrically connected to the shield electrode 20, for example, as shown. In other embodiments, more or fewer than two additional shield electrodes could be disposed at any desired and suitable location(s) on the vessel wall. In further embodiments, a single shield electrode 20 could extend substantially beyond the area of the second electrode 16, for example, to other portions of the vessel wall W. For example, a single shield electrode 20 could extent to a portion or portions of the vessel wall W occupied by the second and/or third shield electrodes 20′, 20″ as shown in FIG. 2A. In an embodiment, the apparatus 10 and any or all of the additional shield electrodes, if provided, could be partially or fully embedded in the wall W of the vessel V. In an embodiment, an additional shield electrode could overlie the first electrode 14 (separated therefrom by the dielectric layer 18 or another dielectric (or insulating) layer), although such an additional shield electrode might not provide meaningful additional isolation.

The drawings may show gaps between the foregoing electrodes 14, 16, 20, 20′, 20″ and the structures (for example, the substrate 12, the dielectric layer 18, or the vessel wall W) upon which they are disposed. Such gaps generally are shown for clarity and would not exist in a typical embodiment. For example, the drive and sense electrodes 14, 16 typically would be deposited directly onto the substrate 12, the insulting layer 18 typically would be deposited directly onto the sense electrode, and the shield electrode 20 typically would be deposited directly onto the insulating layer. Also, any gap that may be shown between the substrate 12 and the wall W typically would be filled with an adhesive bonding the substrate to the wall. In an embodiment, the substrate 12 could be omitted and the foregoing electrode and insulating layer structure could be deposited directly onto the wall W.

As suggested above, the apparatus 10 may be used to detect the presence of a fluid F within the vessel V proximate the electrode structure comprising the first electrode 14, the second electrode 16, and the shield electrode 20. For example, the controller 22 may be operated to periodically provide excitation signals to the first electrode 14. The controller 22 also may be operated to periodically detect voltage signals at the first electrode 14 and the second electrode 18. The controller 22 further may be operated to determine the mutual capacitance C or information indicative of the mutual capacitance C between the first electrode 14 and the second electrode 16 based on the foregoing signals.

With the fluid F not present proximate the foregoing electrode structure, the capacitance C may vary insignificantly about a baseline capacitance. With the fluid F present proximate the foregoing electrode structure, the capacitance C may vary significantly from the baseline capacitance due to the fluid's effect as a dielectric in an electric field E established between the first electrode 14 and the second electrode 16 in response to the excitation signals provided to the first electrode by the controller 22. The controller 22 may be configured to output a signal indicative of the presence of the fluid F proximate the foregoing electrode structure when the capacitance C varies from the baseline capacitance by at least a predetermined amount.

As suggested above, the amplifier 24 drives the shield electrode 20 at a potential equal to the potential at the second electrode 16. Because the shield electrode 20 is driven at the same potential as the second electrode 16, the electric field lines E that otherwise would be directed from the first electrode 14 to the side of the second electrode 16 facing the shield electrode 20 are canceled or otherwise diverted away from the side of the second electrode facing the shield electrode. Consequently, the electric field E emanating from the first electrode 14 is directed to the non-shield side (or fluid side) of the second electrode 16. With the sensor apparatus 10 applied to the wall W of the vessel V, as described above, the electric field E emanating from the first electrode 14 is thereby directed into the vessel V. (The operation of the shield electrode 20 also shields the second electrode 16 from external electrical effects, for example, electrical noise and interference.)

Because the foregoing operation of the shield electrode 20 directs the electric field E into the vessel V, the ability of the apparatus 10 to detect the presence of fluid F therein is enhanced compared to a similar apparatus lacking the shield electrode. The operation of the shield electrode 20 also may reduce the baseline capacitance. More specifically, the shield electrode 20 tends to isolate the sense electrode 16 from parasitic capacitance, which may contribute to the foregoing baseline capacitance. As such, the apparatus 10 may be operated using a multiple pulse (or burst) measurement technique involving a greater number of signal pulses than non-burst measurement techniques. Use of the burst measurement technique instead of non-burst measurement techniques can significantly increase the signal-to-noise ratio and the output signal level of the apparatus 10.

In an embodiment, the apparatus 10 could be configured to simply detect the presence or absence of the fluid F in the vessel V. In such an embodiment, the apparatus could provide a first binary output indicative of the capacitance between the first and second electrodes 14, 16 being less than a predetermined threshold or a second binary output indicative of the capacitance between the first and second electrodes being in excess of the predetermined threshold or another predetermined threshold. In another embodiment, apparatus 10 could be configured to detect the level of the fluid F in the vessel V. In such an embodiment, the apparatus could provide an analog output indicative of the level or height of the fluid F within the vessel compared to the height of the first and second electrodes 14, 16.

The embodiments shown and described are illustrative and not limiting. Features shown and/or described in connection with any embodiment could be incorporated into any other embodiment to the greatest extent possible.

1. A sensor configured for detecting the presence of fluid in a vessel, the sensor comprising:
a dielectric substrate configured for attachment to the vessel;
a drive electrode disposed on said substrate;
a sense electrode disposed on said substrate in side-by-side relationship with said drive electrode;
an insulating layer disposed on and overlying at least a portion of said sense electrode;
a shield electrode disposed on said insulating layer, said shield electrode overlying the entirety of said sense electrode;
a controller electrically coupled to said drive electrode and said sense electrode, said controller configured to provide excitation signals to said drive electrode and to detect signals from said drive electrode and said sense electrode indicative of capacitance between said drive electrode and said sense electrode; and
an amplifier having an input connected to said sense electrode and an output connected to said shield electrode.

2. The sensor of claim 1 wherein said amplifier is configured to drive said shield electrode to the same potential as said sense electrode.

3. The sensor of claim 1 wherein said amplifier is an operational amplifier in a non-inverting unity gain configuration.

4. The sensor of claim 1 wherein said drive electrode is a low impedance electrode.

5. The sensor of claim 4 wherein said sense electrode is a high impedance electrode.

6. The sensor of claim 5 wherein said amplifier drives said shield electrode to the same potential as said sense electrode.

7. The sensor of claim 1 wherein said sensor is disposed on an outer surface of a wall of said vessel.

8. The sensor of claim 1 wherein at least one of said drive electrode and said sense electrode is configured as a thin conductive pad of open or closed geometry.

9. The sensor of claim 8 wherein at least one of said drive electrode and said sense electrode is generally rectangular.

10. The sensor of claim 1 wherein said shield electrode operates to divert electric field lines emanating from said drive electrode away from a surface of said sense electrode facing said shield electrode.

11. The sensor of claim 1 wherein said sensor is disposed within or upon an inner or outer surface of a wall of said vessel.

12. The combination of claim 11 further comprising at least one additional shield electrode disposed within or upon said inner or outer surface of said wall of said vessel and spaced apart from said sense electrode.

13. The combination of claim 11 wherein said shield electrode is further disposed within or upon said inner or outer surface of said wall of said vessel and spaced apart from said sense electrode.

14. The combination of claim 11 further comprising an additional shield electrode overlying said drive electrode and spaced therefrom by an intervening insulating layer.

15. The sensor of claim 1 further comprising an additional shield electrode overlying said drive electrode and spaced therefrom by an intervening insulating layer.

16. The sensor of claim 1 wherein said controller is configured to provide said excitation signals and detect said signals indicative of capacitance in a burst mode of operation.

17. The sensor of claim 1 wherein said controller is configure to provide a first binary output indicative of said capacitance being less than a predetermined threshold and a second binary output indicative of said capacitance being in excess of said predetermined threshold or another predetermined threshold.

18. The sensor of claim 1 wherein said controller is configure to provide an analog output indicative of said capacitance.
